(19) United States
(12) Patent Application Publication
(10) Pub. No.: US 2024/0311326 A1
(43) Pub. Date: Sep. 19, 2024

(54) Controlling Driver Access Based on Docking Status

(71) Applicant: Hewlett-Packard Development Company, L.P., Spring, TX (US)

(72) Inventor: Osaid Ahmed Shamsi, Spring, TX (US)

(21) Appl. No.: 18/571,141

(22) PCT Filed: Jun. 30, 2021
(86) PCT No.: PCT/US2021/040013

§ 371 Date: Dec. 15, 2023

(51) Int. Cl. G06F 13/40

(52) U.S. Cl. CPC G06F 13/4081

(57) ABSTRACT

An example method in a dock management controller of a main computing device includes storing. in a designated storage region controlled by the dock management controller. a driver for a component of the main computing device: receiving a docking status of the main computing device: and when the docking status indicates that the main computing device is engaged by a second computing device. exposing the designated storage region for access by the second computing device to allow the second computing device to access the driver to utilize the component of the main computing device as a peripheral device.

### BACKGROUND

Computing devices, such as all-in-one computing devices, may act as docks to other computing devices, such as laptops, tablets, and the like. The docked computing device uses corresponding drivers to interact with the internal and connected devices.

### BRIEF DESCRIPTION OF THE DRAWINGS

FIG. 1 is a flowchart of an example method of controlling driver access based on docking status.

FIG. 2 is a block diagram of an example dock management subsystem to control driver access based on docking status.

FIG. 3 is a block diagram of an example computing device which may control driver access based on docking status.

FIG. 4 is a flowchart of an example method of controlling driver access based on docking status.

### DETAILED DESCRIPTION

Often, the drivers for internal and connected components of all-in-one computing devices are installed upon manufacture of the all-in-one computing device. Hence, docked computing devices may not have the drivers pre-installed, and a user may download the relevant drivers from a manufacturer website. This may be inconvenient and time consuming for the user to find the appropriate drivers. Further, suitable inbox drivers may not be readily available, since the drivers for such all-in-one built-in components are not usually used by devices which do not have the relevant drivers pre-installed during manufacture.

An example computing device capable of acting as a docking device includes a designated storage region storing drivers for its components. A dock management controller controlling the designated storage region may determine the docking status of the main computing device, and expose the designated storage region to the appropriate device. That is, when the docking status indicates that the main computing device is engaged by a second computing device, the dock management controller exposes the designated storage region to the second computing device to allow the docked second computing device to access and install the drivers to utilize the components of the main computing device as peripheral devices. Thus, any docked second computing device may have convenient access to the drivers for installation to allow the docked device to use the components of the main computing device, including all-in-one built-in components. This reduces the time spent for users to manually download the relevant drivers, as well as the possibility of error in installing an incorrect driver. When the docking status indicates that the main computing device is unengaged, the dock management controller exposes the designated storage region to the main processor of the main computing device as a mass storage device. Notably, the designated storage region is distinct from the boot drive and other drives pertaining to the functioning of the main computing device to restrict access to such drives by the docked second computing device. In other words, the example computing devices provides convenient, automatic access to the relevant drivers in the designated storage region, while protecting the main drives of the main computing device from external access and tampering.

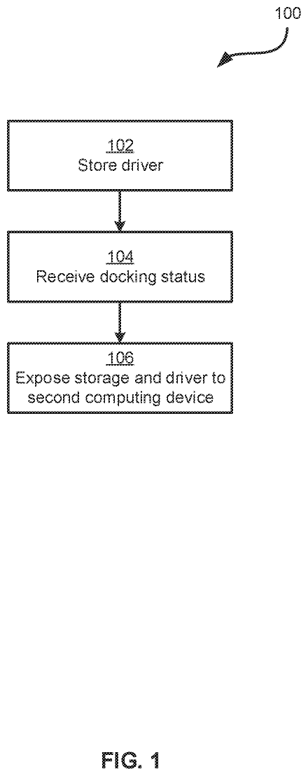

FIG. 1 shows a flowchart of an example method 100 of controlling driver access based on docking status in a dock management controller. For example, the dock management controller may be implemented in a main computing device capable of acting as a dock for a second computing device, such as a laptop computer, a tablet, a notebook computer, or the like. For example, the computing device may be an all-in-one computing device including components such as a display, built-in speakers, and the like which may be enumerated to the docked second computing device for use by the second computing device.

At block 102, a driver for a component of the main computing device is stored in a designated storage region controlled by the dock management controller. The driver is to allow computing devices to interact with the component. For example, the display of the all-in-one computing device may be controlled by a graphics card. Accordingly, the designated storage region may store a driver for the graphics card to allow docked computing devices to interact with the graphics card and utilize the display. In other examples, the component may be a peripheral device of the main computing device (e.g., a connected keyboard, mouse, printer, or the like), and the driver may be a corresponding driver for the peripheral device.

The designated storage region may be a non-volatile storage medium, and in particular, an electronically erasable storage medium such as electrically erasable programmable read-only memory, flash memory, or the like. The designated storage region may be a discrete storage medium controlled by the dock management controller or may be a partitioned region of a storage medium of the main computing device.

At block 104, the dock management controller receives a docking status of the main computing device. For example, the docking status may indicate that the main computing device is engaged by a second computing device (i.e., that the second computing device is docked to the all-in-one computing device) or that the main computing device is unengaged.

At block 106, when the docking status indicates that the main computing device is engaged by a second computing device, the dock management controller exposes the designated storage region for access by the second computing device. That is, the dock management controller may enumerate to the second computing device to allow the second computing device to view and access the designated storage region, for example, as a mass storage device. The second computing device may then access the driver stored in the designated storage region and may install said driver locally to allow the second computing device to utilize the component of the main computing device as a peripheral device. For example, the docked second computing device may install the driver for the graphics card to allow the second computing device to extend or duplicate its display to the display of the all-in-one computing device.

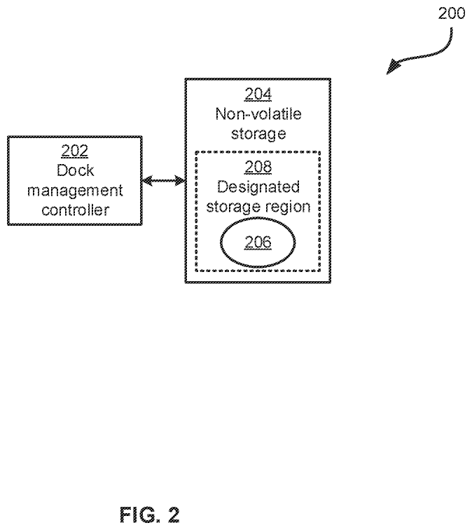

Referring now to FIG. 2, a block diagram of an example dock management subsystem 200 is depicted. The dock management subsystem 200 includes a dock management controller 202 and a designated storage region 208 of a non-volatile storage medium 204. The dock management subsystem 200 is implemented in a main computing device capable of acting as a dock for a second computing device.

The dock management controller 202 may be a microcontroller, a microprocessor, a processing core, or similar device capable of executing instructions. The dock management controller 202 may also include or be interconnected with a non-transitory machine-readable storage medium that may be electronic, magnetic, optical, or other physical storage device that stores executable instructions allowing the dock management controller 202 to perform the functions described herein. For example, the instructions may cause the dock management controller 202 to perform the method 100.

The designated storage region 208 is a region of the non-volatile storage medium 204 which may be any suitable storage medium, and in particular, an electronically erasable storage medium such as electrically erasable programmable read-only memory, flash memory, or the like. The designated storage region 208 stores a driver 206 for a component of the main computing device. In some examples, the designated storage region 208 may comprise the whole of the storage medium 204. In other examples, the designated storage region 208 may comprise a partitioned region of the storage medium 204. The driver 206 stored in the designated storage region 208, when installed at the second computing device, allows the second computing device to interact with the corresponding component of the main computing device.

The designated storage region 208 may be designated as read-only to restrict the removal and/or tampering of the driver 206, or the designated storage region 208 may be designated as read-write, for example to allow users to remove, add, or modify the drivers 206 stored in the designated storage region 208 as desired. In still further examples, the designated storage region 208 may itself be partitioned into a read-only region and a read-write region.

In operation, the dock management subsystem 200 determines the docking status of the main computing device and enumerates the dock management controller 202 and the components of the main computing device, including built-in components and peripheral devices, to the correct computing system based on the docking status. For example, if the docking status indicates that the main computing device is engaged by a second computing device, the dock management controller 202 may expose the designated storage region 208, to the second computing device as a mass storage device. The second computing device may then access and install the driver 206 locally to allow the second computing device to utilize the component of the main computing device.

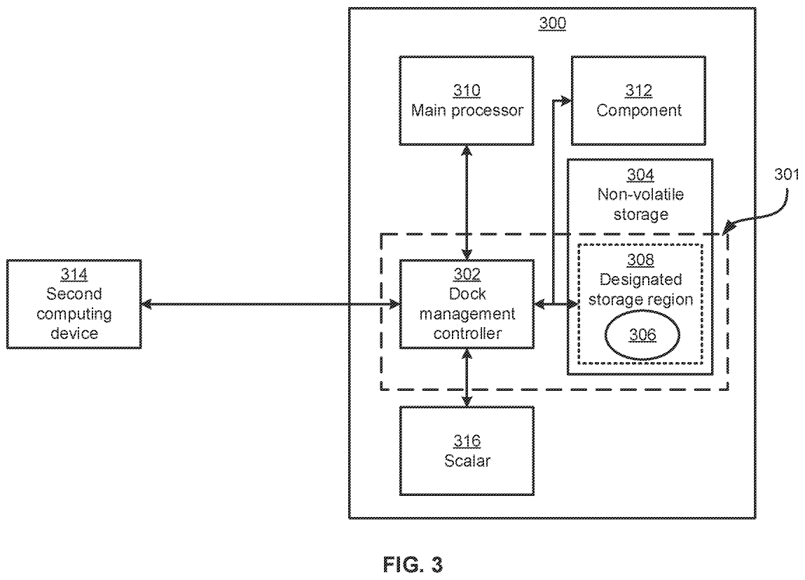

FIG. 3 is a block diagram of an example main computing device 300

controlling driver access based on docking status. The main computing device 300 may be a desktop computer, such as an all-in-one computer, and includes a main processor 310, and a component 312. Thus, the main processor 310 may act as a CPU for the main computing device 300. The component 312 is operable as part of the main computing device 300. For example, the component 312 may be a built-in display, speakers, or the like to allow the main computing device 300 to operate as a stand-alone computing device. The main computing device 300 may include a plurality of different components 312. In other examples, in addition to built-in components of the all-in-one computing device, the components 312 may include peripheral devices, such as a connected keyboard, mouse, printer, or the like.

The main computing device 300 is additionally capable of acting as a dock for a second computing device 314. The second computing device 314 may be a laptop computer, a tablet, a notebook computer, or the like. The component 312 of the computing device 300 is additionally capable of being enumerated to the second computing device 314 for use by the second computing device 314 as a peripheral device. For example, the component 312 may be a display which the second computing device 314 may use to extend or duplicate its own display.

To manage the docking aspects, the main computing device 300 further includes a dock management subsystem 301. The dock management subsystem 301 is similar to the dock management subsystem 200 and includes a dock management controller 302 and a designated storage region 308 of a non-volatile storage medium 304.

The dock management controller 302 may be a microcontroller, a microprocessor, a processing core, or similar device capable of executing instructions to perform the functions described herein.

The designated storage region 308 is a region of the non-volatile storage medium 304, which may be any suitable storage medium, and in particular, an electronically erasable storage medium such as electrically erasable programmable read-only memory, flash memory, or the like. The designated storage region 308 stores a driver 306 for the component 312 of the main computing device 300. As will be appreciated, the designated storage region 308 may include a corresponding driver 306 for each component 312 which may be enumerated to the docked second computing device 314. The driver 306 stored in the designated storage region 308, when installed at the second computing device 314, allows the second computing device 314 to interact with the corresponding component 312 of the main computing device 300.

In some examples, the designated storage region 308 may comprise the whole of the storage medium 304. In other examples, the designated storage region 308 may comprise a partitioned region of the storage medium 304. Notably, the designated storage region 308 is separate from a boot drive and other drives pertaining specifically to the functioning of the main computing device 300 as a stand-alone computing device. That is, the designated storage region 308 may be accessed independently of the boot drive so that the boot drive need not be exposed to the docked second computing device 314.

The designated storage region 308 may be designated as read-only to restrict the removal and/or tampering of the driver 306. For example, the designated storage region 308 may be preloaded during manufacture with drivers 306 for built-in components 312 of the main computing device 300, such as a display, speakers, and the like. The read-only nature of the designated storage region 308 may thus serve to restrict removal of the drivers for such built-in components which may be enumerated to the second computing device 314 docked to the main computing device 300.

In other examples, the designated storage region 308 may be designated as read-write to allow users to remove, add, or modify the drivers 306 stored in the designated storage region 308 as desired. For example, the designated storage region 308 may be loaded by a computer technician in an enterprise setting with additional drivers 306 for other peripheral device components 312 connected to the main computing device 300, such as a printer, keyboard, mouse, and the like. This may be of particular use when the main computing device 300 may serve as a dock for many second computing devices 314, to facilitate the installation of the requisite drivers 306 at each of the second computing devices 314.

In still further examples, the designated storage region 308 may itself be partitioned into a read-only region and a read-write region to restrict removal of drivers for built-in components of the main computing device 300, while also allowing users to add drivers for peripheral devices.

The main computing device 300 may additionally include a scalar 316 to communicate the docking status to the dock management subsystem 301. The scalar 316 may, in turn, be connected to an input device, such as a button or a switch, which may accept input from a user. The user may use the input device to select the desired docking state of the main computing device 300. For example, the input device may be a switch, or an on-screen-display menu controlled by the scalar 316 to toggle between the engaged docking status and the unengaged docking status. The scalar 316 may therefore be to receive the docking status as input and to transmit the docking status to the dock management controller 302 for further processing.

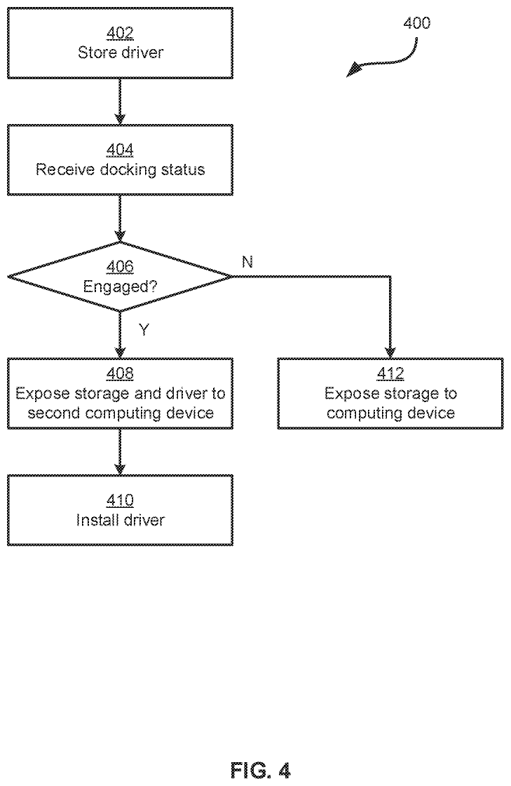

Referring now to FIG. 4, a flowchart of another example method 400 of controlling driver access based on docking status is depicted. The method 400 will be described in conjunction with its performance in the computing device 300, and in particular by the dock management controller 302. In other examples, the method 400 may be performed in other suitable devices and/or systems.

At block 402, the driver 306 for the component 312 of the main computing device 300 is stored in a designated storage region, such as the non-volatile storage medium 304, controlled by the dock management controller 302.

At block 404, the dock management controller 302 receives a docking status of the main computing device 300. For example, a user may provide an input at a physical button or on-screen-display menu connected to the scalar 316. The input may be a selection of an engaged (e.g., a docking display mode) or an unengaged (e.g., a desktop mode) state of the main computing device 300. The scalar 316 may then transmit the docking status to the dock management controller 302.

In other examples, other manners of determining the docking status are contemplated. For example, the second computing device 314 may be docked at a designated docking port, and if the dock management controller 302 detects the second computing device 314 via the designated docking port, the dock management controller 302 may determine that the docking status is engaged.

At block 406, if the docking status is engaged, the dock management controller 302 proceeds to block 408. If the docking status is unengaged, the dock management controller 302 proceeds to block 412.

At block 408, when the docking status indicates that the main computing device 300 is engaged by the second computing device 314, the dock management controller exposes the designated storage region 308 for access by the second computing device 314. For example, the dock management controller 302 may enumerate to the second computing device 314 to allow the second computing device 314 to view and access the designated storage region 308 as a mass storage device.

At block 410, the second computing device 314 may install the driver 306 locally to allow it to connect to and utilize the component 312 of the main computing device 300 as a peripheral device. In some examples, the driver 306 may be associated with an auto-installer. In particular, when the auto-installer determines that the driver 306 is not yet installed locally at the second computing device 314, the auto-installer may automatically install the driver 306.

In other examples, the driver 306 may be associated with a

notification manager. In particular, when the notification manager determines that the driver 306 is not yet installed locally at the second computing device 314, the notification manager may provide a prompt to install the driver 306. The prompt may allow a user of the second computing device to confirm or reject the installation of the driver 306.

In other examples, rather than the auto-installer or notification manager detecting the driver 306 at the second computing device 314, the second computing device 314 may determine the installation status of the driver 306. The second computing device 314 may then suppress the automatic installation or prompt when the driver 306 is already installed and allow the automatic installation or prompt when the driver 306 is not yet installed at the second computing device 314.

At block 412, when the docking status is unengaged, the dock management controller 302 exposes the designated storage region 308 to the main computing device 300. For example, the dock management controller 302 may be enumerated to the main computing device 300 to allow access to the storage medium 304, and in particular the designated storage region 308, as a mass storage device.

As described above, an example method and computing device for controlling driver access based on docking status includes a dock management controller which uses the docking status to expose a designated storage region to the appropriate computing device. In particular, when the docking status indicates that the main computing device is engaged by a second computing device, the dock management controller enumerates itself and the components of the main computing device to the second computing device. The second computing device thus has access to the drivers stored in the designated storage region. The drivers may be automatically installed or provide a prompt to a user for installation when the drivers are not yet installed at the second computing device. Thus, the drivers may be conveniently made available to any second computing device which docks to the main computing device.

The scope of the claims should not be limited by the above examples, but should be given the broadest interpretation consistent with the description as a whole.

1. A method in a dock management controller of a main computing device, the method comprising:
storing, in a designated storage region controlled by the dock management controller, a driver for a component of the main computing device;
receiving a docking status of the main computing device; and
when the docking status indicates that the main computing device is engaged by a second computing device, exposing the designated storage region for access by the second computing device to allow the second computing device to access the driver to utilize the component of the main computing device as a peripheral device.

2. The method of claim 1, further comprising providing a prompt to install the driver at the second computing device when the driver is not yet installed at the second computing device.

3. The method of claim 1, further comprising automatically installing the driver at the second computing device when the driver is not yet installed at the second computing device.

4. The method of claim 1, wherein the designated storage region is exposed to the second computing device as a mass storage device.

5. The method of claim 1, further comprising, when the docking status is unengaged, exposing the designated storage region to the main computing device.

6. A dock management subsystem of a main computing device, the dock management subsystem comprising:
a non-volatile storage medium to store a driver for a component of the main computing device, the driver stored in a designated storage region of the non-volatile storage medium;
a dock management controller interconnected with the non-volatile storage medium, the dock management controller to:
determine a docking status of the main computing device; and
when the docking status indicates that the main computing device is engaged by a second computing device:
enumerate the dock management controller and the component of the main computing device to the second computing device; and
expose the designated storage region to the second computing device to allow the second computing device to access the driver to utilize the component of the main computing device as a peripheral device.

7. The dock management subsystem of claim 6, wherein the designated storage region comprises a whole of the non-volatile storage medium.

8. The dock management subsystem of claim 6, wherein the designated storage region comprises a partitioned region of the non-volatile storage medium.

9. The dock management subsystem of claim 6, wherein the designated storage region is designated as read-only to restrict removal of the driver.

10. An all-in-one computing device capable of acting as a dock for a second computing device, the all-in-one computing device comprising:
a main processor to operate the all-in-one computing device;
a component operable as part of the all-in-one computing device and capable of being enumerated to the second computing device;
a non-volatile storage medium storing a driver for the component in a designated storage region; and
a dock management controller to expose the designated storage region to the second computing device to allow the second computing device to access the driver when the second computing device is docked to the all-in-one computing device.

11. The all-in-one computing device of claim 10, wherein the driver is preloaded to the designated storage region when the component is a built-in component of the all-in-one computing device.

12. The all-in-one computing device of claim 11, wherein the designated storage region is designated as read-only to restrict removal of the driver.

13. The all-in-one computing device of claim 10, wherein the designated storage region is partitioned from a boot drive of the all-in-one computing device.

14. The all-in-one computing device of claim 10, wherein the dock management controller is to expose the designated storage region to the main processor to allow access to the designated storage region as a mass storage device.

15. The all-in-one computing device of claim 10, further comprising a scalar connected to an input device, the scalar to receive a docking status as input from the input device and transmit the docking status to the dock management controller.
